(19) United States
(12) Patent Application Publication
(10) Pub. No.: US 2008/0183839 A1
(43) Pub. Date: Jul. 31, 2008

(54) System For Computer To Mobile Device Place Shifting

(76) Inventors: Michel A.D. Shuqair, Arnhem (NL); Remco Schouten, Leiden (NL); Gerardus J. Vivie, Amersfoort (NL); Albert J. Dost, Huizen (NL)

Correspondence Address: ST. ONGE STEWARD JOHNSTON & REENS, LLC, 986 BEDFORD STREET, STAMFORD, CT, 06905-5619, US

(21) Appl. No.: 11/627,818

(22) Filed: Jan. 26, 2007

(51) Int. Cl. G06F 15/16; G06F 3/048; G06F 21/00

(52) U.S. Cl. 709/217; 715/810; 726/7

(57) ABSTRACT

A system for remotely accessing content of a computer via a mobile device, including a mobile device, a system server for receiving a connection request from the mobile device to establish a connection with a computer, the computer including a plurality of electronic files, software executing on the system server for authenticating the mobile device and the computer, the system server establishing a connection upon authentication, software executing on the computer for receiving a request from the mobile device to send a selected one of the electronic files to a destination device, a translation module for translating a format of the selected electronic files based on a device type of the destination device, and a file transfer module for sending the translated electronic file to the destination device.

### FIELD OF THE INVENTION

The invention relates to place shifting technology, and more specifically to a system and method for remotely accessing content of a computer via a mobile device.

### BACKGROUND OF THE INVENTION

“Place shifting” generally relates to moving a point of access of media and applications residing in one place to another place. A demand for the ability to work whenever and wherever has driven the development of some known place shifting technology. For example, U.S. Pat. No. 6,928,479 teaches a system for providing a private communication portal between two computers. The communication portal of the '479 patent provides a means to remotely manage and access messages such as voice messages, faxes, and e-mail stored on a computer.

U.S. Pat. No. 6,938,076 teaches a similar system for providing a private communication portal between a computer and a wireless device. The system of the '076 patent provides a means for notifying a wireless device when a message (e.g., voicemail, email, or fax) is received by the computer. Upon notification of the message, the wireless device may access the computer to retrieve the message.

Therefore, while some systems are known for retrieving messages from a computer via a second computer or wireless device, there is desire in the art for a system and method for accessing a variety of information and electronic files on remote computers. Further, there is a desire for a system which provides a means to access and deliver files of any type, format, and size to mobile devices. Also desired is a system capable of two-way communication between a mobile device and a computer.

### SUMMARY OF THE INVENTION

Accordingly, it is an object of the present invention to provide system for remotely accessing content of any type or format stored on a computer via a mobile device.

It is a further object of the present invention to provide system for remotely accessing content on a computer via a mobile device including a translation module for translating a type or format of a file based on characteristics of the mobile device or other destination device.

It is a further object of the present invention to provide system for receiving on a wireless device streamed multimedia content (e.g., music, video, television) stored on or otherwise accessible by a personal computer.

It is a further object to provide such a system which provides two-way data communication between a computer and wireless device for accessing content on the wireless device from the computer.

These and other objectives are achieved by providing a system for remotely accessing content of a computer via a mobile device, including a mobile device, a system server for receiving a connection request from the mobile device to establish a connection with a computer, the computer including a plurality of electronic files, software executing on the system server for authenticating the mobile device and the computer, the system server establishing a connection upon authentication, software executing on the computer for receiving a request from the mobile device to send a selected one of the electronic files to a destination device, a translation module for translating a format of the selected electronic files based on a device type of the destination device, and a file transfer module for sending the translated electronic file to the destination device.

Other objects of the present invention are achieved by provision of a system for remotely accessing content of a computer via a mobile device, including a mobile device, a system server for receiving a connection request from the mobile device to establish a connection with a computer, the computer including a plurality of electronic files, software executing on the system server for authenticating the mobile device and the computer, the system server establishing a connection upon authentication, software executing on the computer for receiving a request from the mobile device to retrieve a selected one of the electronic files, a translation module for translating a format of the selected electronic files based on at least one parameter of the mobile device, and a file transfer module for transferring the translated electronic file to the mobile device. In some exemplary embodiments, the selected electronic file is a multimedia file. The translated electronic file may further be continuously streamed by the file transfer module to the mobile device.

Further provided is a method for remotely accessing content of a computer via a mobile device, including the steps of receiving a connection request from a mobile device to establish a connection with a computer, the computer including a plurality of electronic files, authenticating the mobile device and the computer, establishing a connection upon authentication, receiving a request from the mobile device to send a selected one of the electronic files to a destination device, translating a format of the selected electronic files based on a device type of the destination device, and sending the translated electronic file to the destination device.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is a schematic diagram of a system for providing remote access between a computer and a mobile device according to an exemplary embodiment of the present invention.

FIG. 2 is another schematic diagram of a system for providing remote access between a computer and a mobile device according to an exemplary embodiment of the present invention.

FIG. 3 is another schematic diagram of a system for providing remote access between a computer and a mobile device according to an exemplary embodiment of the present invention.

FIG. 4 is another schematic diagram of a system for providing remote access between a computer and a mobile device according to an exemplary embodiment of the present invention.

FIG. 5 illustrates a method for providing a secure connection and remote access between a computer and a mobile device employable by the systems shown in FIGS. 1-4.

FIG. 6 illustrates a method for transferring an electronic file employable by the systems shown in FIGS. 1-4.

### DETAILED DESCRIPTION OF THE INVENTION

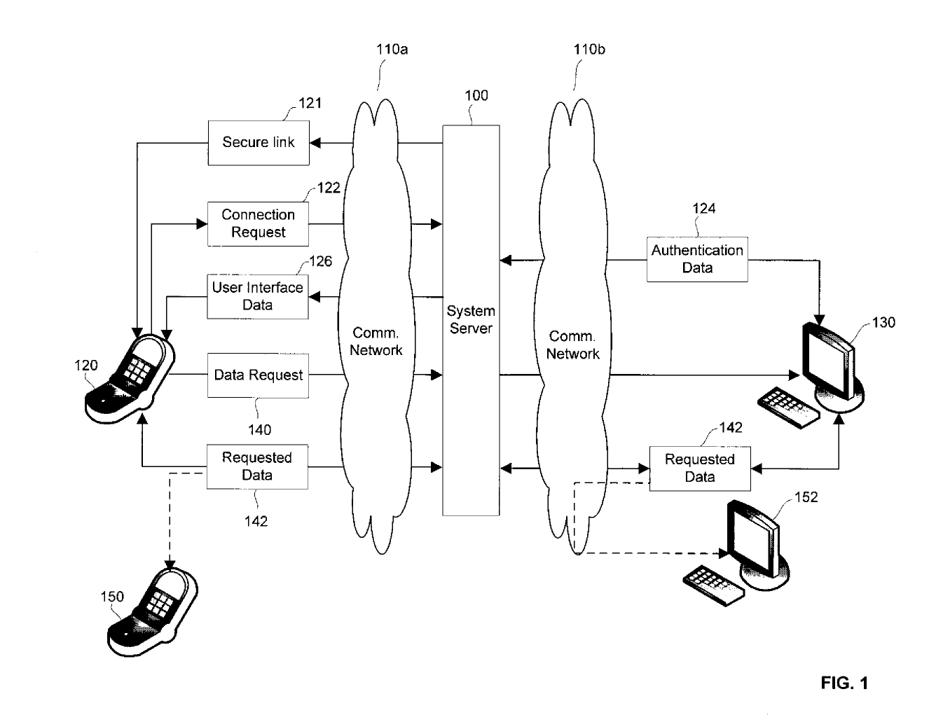

FIG. 1 shows a system for remotely accessing content of a computer via a mobile device according to an exemplary embodiment of the present invention. The system is useful for reviewing, editing and/or receiving information and electronic files from a personal computer through a mobile phone or device. The system is also useful providing information and electronic files to the computer from the mobile device.

The system includes at least one system server 100 accessible to a communication network 110 (e.g., 110a/110b). The communication network 110 may be, e.g., an intranet, the Internet, a LAN (“Local Area Network”), a WAN (“Wide Area Network”), a wireless or cellular network, or a combination thereof.

The exemplary system further includes at least one mobile device 120. The mobile device 120 may be a mobile telephone, a personal digital assistant (“PDA”), a smartphone, or any mobile device capable of accessing a communication network (e.g., 110). Each mobile device 120 preferably includes a mobile Internet browser. The system further includes at least one computer 130 (e.g., personal computer, PC and/or Mac) having access to the communication network 110. The system server 100 is connectable to each of the mobile device 120 and computer 130 via the communication network 110. The computer 130 includes any number of electronic files, such as document files, programs, or multimedia files (e.g., music, MP3 files, photos, video, etc). The computer 130 may further have access to additional information, files and/or streaming video via a television tuner and one or more webcams. Further, the computer 130 may upload any number of files and/or content from other sources, e.g., upon receipt of a request for such content from the mobile device 120.

As shown in FIG. 1, the system server 100 may receive a connection request 122 from the mobile device 120. The connection request 122 includes a request to establish a connection with a particular computer (e.g., the computer 130). For example, the request 122 may be initiated via a secure link 121 stored on the mobile device 120. Upon receiving such a request 122, the system server 100 may attempt to authenticate the mobile device 120 and/or the computer 130. For example, the mobile device 120 and computer 130 may share at least one unique code (e.g., key, token) which is verified by the system server 100. In some embodiments, at least a portion of the unique code or key is embedded in the secure link 121. Upon authentication, software executing on said system server 100 establishes a secure connection between the mobile device 120 and computer 130.

The system server 100 generates and provides user interface data 126 to the mobile device 120 via the communication network 110. In the exemplary embodiment, software executing on the system server 100 generates a user interface accessible by the mobile device 120 via the Internet. The user interface may include, e.g., selectable icons representing at least some of the electronic files, file folders, and/or content available on or accessible by the computer 130. For example, one exemplary user interface includes a hierarchical menu structure for browsing content of the computer 130 and a home page including initial options such as “my pictures,” “my music,” “my videos,” “my webcams,” “my TV,” and/or any other options chosen by the user. In some embodiments, the user interface includes a replication of a menu structure on the particular computer 130. The user interface may further include a search tool for locating a particular file or content on the computer 130.

The system server 100 may then enable the sending of information, data and/or electronic files to and from the computer 130. For example, a user of the mobile device 120 may generate and send a request 140 for data and/or a particular electronic file on the computer 130 via the user interface. In some embodiments, the user of the mobile device 120 may also send information or content (e.g., alone or in combination with a data request 140) for storage on the computer 130.

The computer 130 receives the request 140 and sends the data and/or selected one of the electronic files to a desired destination. For example, the computer 130 may send requested data 142 to the mobile device 120. The data 142 may be temporary viewed or accessed via the mobile device 120, or downloaded and stored thereon. For example, audio or video content may be streamed to the mobile device 120 for entertainment purposes. A user of the mobile device 120 may also choose to download and store a particular multimedia file. For example, a music file may be stored to use a ring-tone on the mobile device 120 or a photo may be stored and set as a background. The destination device need not be the mobile device 120 with which the secure connection is established. The requested data 142 may alternatively be shared with or sent to one or more different mobile devices 150 and/or computers 152.

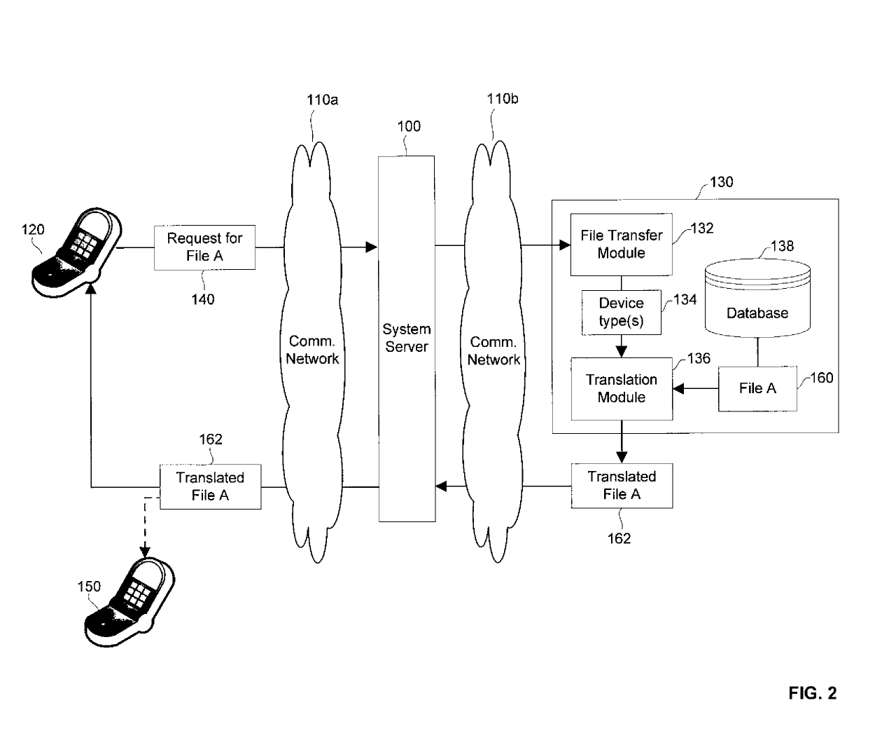

FIG. 2 shows another view of the system for providing remote access between a computer 130 and a mobile device 120. The system includes a file request and/or transfer module 132 for receiving a data or file request 140 and sending the file to the destination device. A requested file 160 may be retrieved from one or more databases accessible by the computer 130.

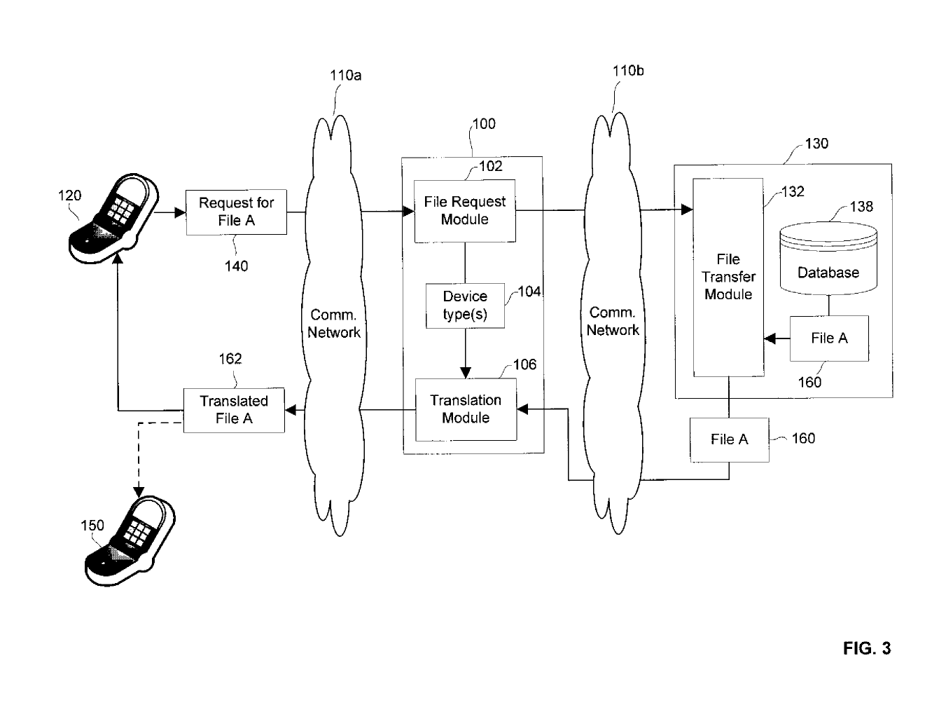

If necessary or desired, a selected file 160 may be translated or converted (e.g., in real time) into a format compatible with (or better suited) for the destination device. For example, the system may include a translation module 136 for translating a selected electronic file 160 based on a device type 134 or other parameter or characteristic (e.g., available software, connection type, service provider, etc.) of the destination device. The translation module 136 may translate any number of characteristics or parameters of the file, e.g., such as the format or type of the file 160, a file size, a resolution, optimal number of lines, etc. The translation module 136 may further translate the file to a proprietary format corresponding to a particular mobile device type and/or service carrier. The translation module 136 may reside on the computer 130 the system server 100, or both. For example, FIG. 3 another view of the system in which the server 100 includes a translation module 106.

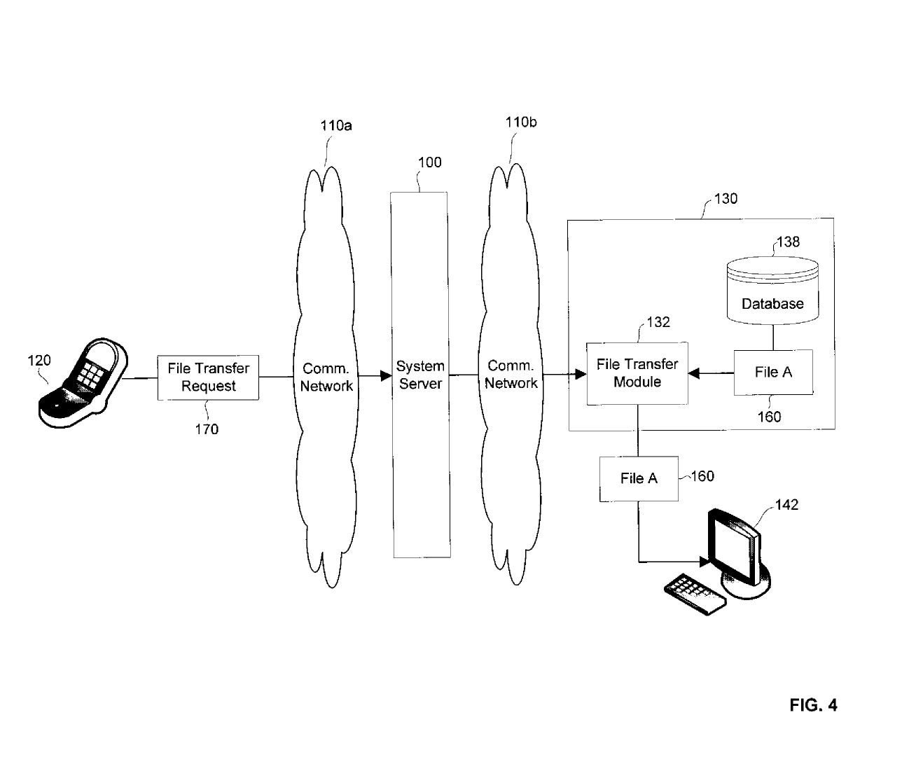

FIG. 4 is another view of a system for providing remote access between a computer and a mobile device according to an exemplary embodiment of the present invention. The system may enable the transfer or sending of a file 160 from the computer 130 in response to a command or request from the mobile device 120. For example, a user of the mobile device 120 may generate a file transmit request 170 to the server 100, e.g., via a user interface generated by the system. The request 170 generally includes the identification of one or more particular files 160 accessible to the computer 130, and a destination. For example, the request 170 may include an SMS (“Short Message Service”) address or email address corresponding to a user of the computer 142. The destination may be entered by the user of the mobile device, or selected from contacts stored on the computer 130. The server 100 communicates the request to the computer 130.

Based on the type or other parameter of the destination device (e.g., computer 142) or a user input to the mobile device 120, a determination is made as to whether the file 160 requires translation. The file 160 may then be transmitted and/or sent to the destination computer 162. For example, the file 160 may be emailed and/or sent by SMS to the computer 142.

In some embodiments, the file 160 corresponds to a similar or related file stored on the mobile device 120. For example, a multimedia file (e.g., song, video, photo, etc.) may be stored on each of the computer 130 and the mobile device 120, possibly in different formats. The file stored on the mobile device 120 may be a smaller size and/or otherwise formatted to be more compatible with the mobile device 120. Using the present invention, a user of the mobile device 120 may therefore send the file stored on the computer 130 (e.g., larger file) to a destination device rather than forwarding the file stored on the mobile 120 (e.g., smaller file). The mobile device 120 therefore remotely controls the computer 130 to initiate sending a particular file or files.

A user of the mobile device 120 may, in some embodiments, choose to send a file from either the mobile device 120 or from the computer 130. Alternatively, some embodiments of the system may send substantially all requested files from the computer 130 rather than from the mobile device 120. For example, any content viewable or residing on the mobile device 120 may also be stored in some format on the computer 130. Therefore, whenever a user elects to send or share a file from the mobile device 120, the file is sent from the computer 130 to the selected destination. The file may be sent, e.g., via email and/or an SMS message. Therefore, not only may the recipient receive a higher quality file (e.g., with no file size limitations), the file transfer is substantially quicker due to it being performed via the computer 130 rather than the mobile device 120. Further, a user of the mobile device 120 may likewise send any file residing only on the computer 130 without first downloading or copying the file to the mobile device 120.

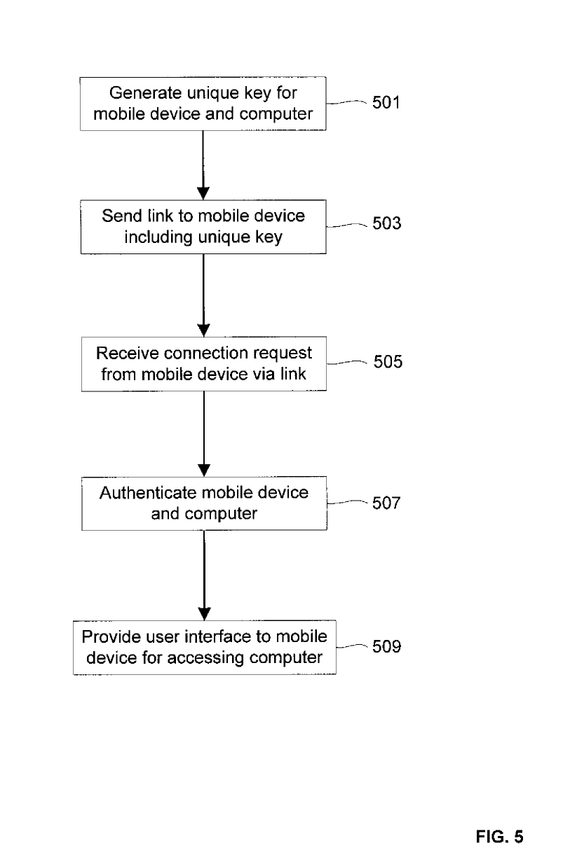

FIG. 5 shows an exemplary method for providing remote access between a computer and a mobile device employable by the systems shown in FIGS. 1-4. The system and/or system server 100 generates or determines at least one unique key and/or token for a particular mobile device (e.g., 120) and a computer (e.g., 130). The unique key may be used for establishing the connection, and for encrypted data transmissions to and from the mobile device 120 and computer 130. The unique key may be generated or determined, e.g., upon a user subscribing to a particular service embodying the present invention (step 501). For example, a user may load a software application (e.g., file transfer module) on the computer 130 and initiate a setup. The setup may include providing information regarding the mobile device 120 such as a device brand and/or type and IMEI (“International Mobile Equipment Identity”) number. In some embodiments, the unique key includes at least a portion of the IMEI. The setup may further include selecting any number of folders, electronic files and/or content on the computer 130 to be accessible via the mobile device 120. Email preferences may further be provided for sending files from the computer 130. In some embodiments, a user may also select a particular port, protocol and/or connection means for accessing the server 100 via the communication network 110.

Following setup on the computer 130, the system server 100 may then provide a Internet link 121 to the mobile device 120 including at least a portion of the unique key (step 503). For example, the system server 100 may provide a tailored and secure link 121 via an SMS or text message to the mobile device 120. However, the link 121 may alternatively be sent by any other known communications means. The link 121 is stored on the mobile device 120. A user of the mobile device 120 may, at any time thereafter, provide a connection request to the server 100 via the link 121 (step 505). In some embodiments, the user must also enter a pre-selected pin (e.g., numeric pin) in combination with the link 121. However, the secure link 121 (e.g., sent via SMS) advantageously provides a means to establish a connection without the necessity for a password or log-in procedure.

Upon receiving a connection request for the mobile device 120, the system server 100 attempts to authenticate each of the mobile device 120 and the computer 130 (step 507). For example, the server 100 may verify the link 121, unique key, and/or information pertaining to the mobile device, such as the IMEI number of the mobile device 120. No connection will be established if the connection request originated from an unauthenticated mobile device. As such, should the secure link 121 be forwarded to a different device, access will not be authorized via the different device. The server 100 may also verify authentication data 124 from the computer 130 (e.g., the unique key, a connection software output, numeric pin, etc). For example, the system server 100 may verify the unique key generated, e.g., when file transfer module and/or setup software was installed on the computer 130. The server 100 may further confirm that there are no existing connections established between the mobile device 120 and computer 130, or between either of the mobile device 120 and computer 130 and any third device.

After each of the mobile device 120 and computer 130 is authenticated, a secure connection is established and the system server 100 provides a user interface to the mobile device (step 509). The user interface is preferably an Internet based user interface, e.g., accessible via a mobile Internet browser of the mobile device 120. As described above, the user interface may include any number of selectable and/or searchable indicators or icons representative of folders, electronic files, and/or applications of the computer 130.

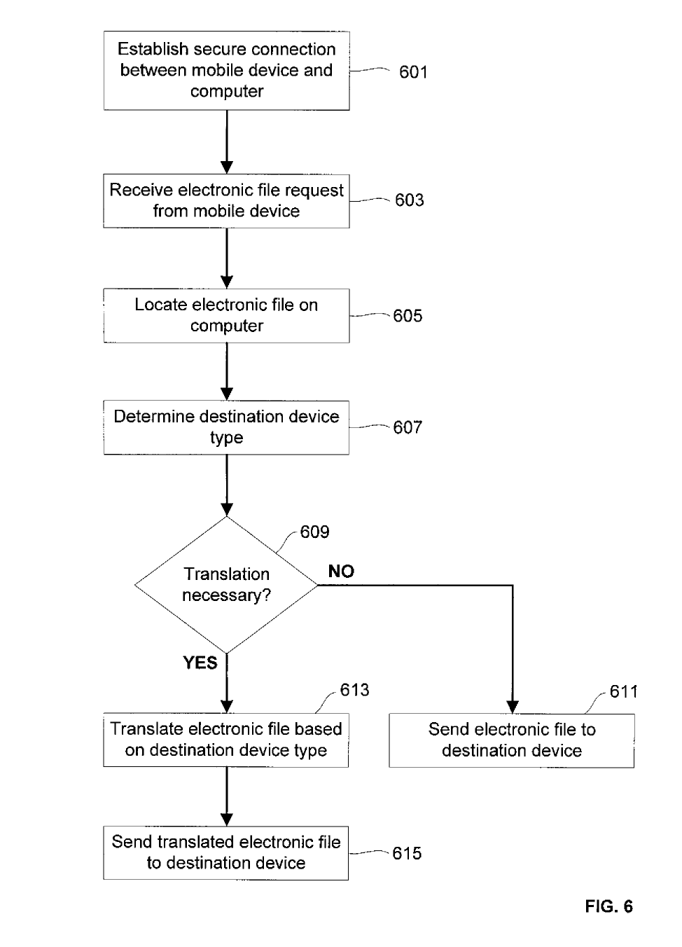

FIG. 6 shows an exemplary method for transferring an electronic file employable by the systems shown in FIGS. 1-4. A secure connection is first established between the mobile device 120 and a computer (e.g., 130) in accordance with the methods and/or means described herein. The system server 100 may then receive an electronic file request 140 from the mobile device 120 (step 601). The request 140 may be a request to view, retrieve, stream, and/or send any number of electronic files or content stored on, or accessible by, the computer 130 (e.g., multimedia files). The desired electronic file is then located or accessed (step 605).

The system may next determine a type or identity of destination device (step 607). For example, the type or identity may be determined from the destination address and/or from information stored in the mobile device 120, server 100, and/or computer 130. The electronic file is translated via a translation module if necessary (steps 609-613). The translated file is then sent and/or streamed to the destination device (step 615). If no translation is necessary, the file is sent in its present and/or default format to the destination device (step 611).

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for remotely accessing content of a computer via a mobile device, comprising:
a mobile device;
a system server for receiving a connection request from said mobile device to establish a connection with a computer, the computer comprising a plurality of electronic files;
software executing on said system server for authenticating said mobile device and the computer, said system server establishing a connection upon authentication;
software executing on the computer for receiving a request from said mobile device to send a selected one of the electronic files to a destination device;
a translation module for translating a format of the selected electronic files based on a device type of the destination device; and
a file transfer module for sending the translated electronic file to the destination device.

2. The system according to claim 1, wherein the destination device is said mobile device.

3. The system according to claim 1, wherein the destination device is one of a second mobile device and a second computer.

4. The system according to claim 1, wherein said translation module compresses the selected electronic file.

5. The system according to claim 1, wherein said file transfer module sends via at least one of an email and an SMS.

6. The system according to claim 1, wherein said translation module resides on said system server.

7. The system according to claim 1, wherein said translation module resides on the computer.

8. The system according to claim 1, wherein the selected electronic file is a multimedia file.

9. The system according to claim 8, wherein the translated electronic file is continuously streamed by the file transfer module to said mobile device.

10. The system according to claim 1, further comprising:
software executing on said system server for sending a multimedia file from said mobile device to the computer.

11. The system according to claim 1, further comprising:
software executing on the computer for receiving a request from said mobile device to upload content to the computer.

12. The system according to claim 1, wherein said software for authenticating determines a unique key assigned to said mobile device and said computer.

13. The system according to claim 1, further comprising:
software executing on said system server for generating a user interface accessible by said mobile device.

14. The system according to claim 1, wherein said system server receives the connection request and the request to send the selected electronic file via a communication network.

15. A system for remotely accessing content of a computer via a mobile device, comprising:
a mobile device;
a system server for receiving a connection request from said mobile device to establish a connection with a computer, the computer comprising a plurality of electronic files;
software executing on said system server for authenticating said mobile device and the computer, said system server establishing a connection upon authentication;
software executing on the computer for receiving a request from said mobile device to retrieve a selected one of the electronic files;
a translation module for translating a format of the selected electronic files based on at least one parameter of said mobile device; and
a file transfer module for transferring the translated electronic file to said mobile device.

16. The system according to claim 15, wherein the parameter is a device type.

17. The system according to claim 15, wherein the selected electronic file is a multimedia file.

18. The system according to claim 15, wherein the translated electronic file is continuously streamed by said file transfer module to said mobile device.

19. The system according to claim 15, further comprising:
software executing on said system server for generating a user interface accessible by said mobile device, the user interface including one or more selectable icons representing at least some of the electronic files.

20. The system according to claim 15, wherein said software for authenticating receives a unique key assigned to said mobile device and said computer.

21. The system according to claim 15, wherein said translation module compresses the selected electronic file.

22. A method for remotely accessing content of a computer via a mobile device, comprising the steps of:
receiving a connection request from a mobile device to establish a connection with a computer, the computer comprising a plurality of electronic files;
authenticating the mobile device and the computer;
establishing a connection upon authentication;
receiving a request from the mobile device to send a selected one of the electronic files to a destination device;
translating a format of the selected electronic files based on a device type of the destination device; and
sending the translated electronic file to the destination device.

23. The method according to claim 22, wherein said step of receiving the connection request includes receiving the connection request via an Internet-based user interface on the mobile device.

24. The method according to claim 22, wherein the destination device is said mobile device.

25. The method according to claim 22, wherein the destination device is one of a second mobile device and a second computer.
